(19) United States
(12) Patent Application Publication
(10) Pub. No.: US 2025/0364866 A1
(43) Pub. Date: Nov. 27, 2025

(54) MOTOR DEVICE

(71) Applicant: MITSUBA Corporation, Gunma (JP)

(72) Inventors: Yuuki Kurosawa, Gunma (JP); HIROTATSU IKENO, Gunma (JP)

(73) Assignee: MITSUBA Corporation, Gunma (JP)

(21) Appl. No.: 19/212,543

(22) Filed: May 19, 2025

(30) Foreign Application Priority Data
May 22, 2024 (JP) 2024-083285

(51) Int. Cl. H02K 7/00; H02K 11/215

(52) U.S. Cl. CPC H02K 7/003; H02K 11/215

(57) ABSTRACT

Provided is a motor device capable of suppressing the occurrence of burrs during assembly, and eliminating the need for the subsequent deburring operation. A rotation shaft 32 includes a columnar portion 33a in which the outer diameter is constant toward the axial direction of the rotation shaft 32, a tapered portion 33b which is provided on one axial side of the columnar portion 33a and in which the outer diameter gradually decreases as the tapered portion 33b extends away from the columnar portion 33a, and an arc-shaped connecting portion 33c which is provided between the columnar portion 33a and the tapered portion 33b. The arc-shaped connecting portion 33c connects the outer peripheral surface of the columnar portion 33a and the outer peripheral surface of the tapered portion 33b with an arc surface when viewed from the radial outer side of the rotation shaft 32. A holder member 61 has a cylindrical body portion 61a into which the columnar portion 33a is press-fitted, and a gap-forming cylindrical portion 61b which is provided on one axial side of the cylindrical body portion 61a and which forms a gap SP with the arc-shaped connecting portion 33c in the radial direction of the rotation shaft 32.

### CROSS-REFERENCE TO RELATED APPLICATION

This application claims the priority benefit of Japanese application serial no. 2024-083285, filed on May 22, 2024. The entirety of the above-mentioned patent application is hereby incorporated by reference herein and made a part of this specification.

### TECHNICAL FIELD

The disclosure relates to a motor device having a rotation shaft and a fixed component fixed to the rotation shaft.

### BACKGROUND

For example, Patent Document 1 (Japanese Patent Application Laid-Open No. 2014-185663) describes a wiper motor which includes an armature shaft including a bearing member mounting portion and a guide small diameter portion that has a smaller diameter than the bearing member mounting portion, and in which an inner race of a ball bearing is fixed by press-fitting to the bearing member mounting portion.

In the technology described in Patent Document 1, when fixing the ball bearing to the bearing member mounting portion, the guide small diameter portion is inserted through the inner race that forms the ball bearing, and then the bearing member mounting portion is press-fitted through a step between the guide small diameter portion and the bearing member mounting portion.

Therefore, when inserting the bearing member mounting portion of the armature shaft into the inner race of the ball bearing, the press-fitting load of the armature shaft increases suddenly. As a result, there is a risk that the corner portion located between the bearing member mounting portion and the step may be cut, or the inner wall of the inner race may be cut, causing so-called “burrs (cutting chips)” to occur.

The disclosure provides a motor device capable of suppressing the occurrence of burrs during assembly, and eliminating the need for the subsequent deburring operation.

### SUMMARY

In one aspect of the disclosure, a motor device includes: a rotation shaft; and a fixed component fixed to the rotation shaft. The rotation shaft includes: a straight portion in which an outer diameter is constant toward an axial direction of the rotation shaft; a tapered portion which is provided on one axial side of the straight portion and in which an outer diameter gradually decreases as the tapered portion extends away from the straight portion; and a connecting portion which is provided between the straight portion and the tapered portion. The connecting portion connects an outer peripheral surface of the straight portion and an outer peripheral surface of the tapered portion with an arc surface when viewed from a radial outer side of the rotation shaft. The fixed component includes: a press-fitting cylindrical portion into which the straight portion is press-fitted; and a gap-forming cylindrical portion which is provided on one axial side of the press-fitting cylindrical portion and which forms a gap with the connecting portion in a radial direction of the rotation shaft.

According to the disclosure, it is possible to realize a motor device capable of suppressing the occurrence of burrs during assembly, and eliminating the need for the subsequent deburring operation.

### BRIEF DESCRIPTION OF THE DRAWINGS

FIG. 1 is a perspective view of a motor device as viewed from the bracket side.

FIG. 2 is a perspective view of the motor device as viewed from the case side.

FIG. 3 is a cross-sectional view showing the internal structure of the motor device.

FIG. 4 is a cross-sectional view showing only the rotor of FIG. 3.

FIG. 5 is a perspective view showing the rotation shaft alone.

FIG. 6 is a perspective view of the magnet unit as viewed from the rotor body side.

FIG. 7 is a perspective view of the magnet unit as viewed from the pinion gear portion side.

FIG. 8 is an enlarged cross-sectional view showing the fixed structure of the magnet unit to the rotation shaft.

FIG. 9 is an assembly explanatory view showing the [component setting process].

FIG. 10 is an assembly explanatory view showing the [rotation shaft moving process].

FIG. 11 is an assembly explanatory view showing the [press-fitting process].

FIG. 12 is a view illustrating the assembled state of the present embodiment.

FIG. 13 is a view corresponding to FIG. 8, showing a comparative example.

FIG. 14 is a view illustrating the assembled state of the comparative example.

FIG. 15 is a view corresponding to FIG. 8, showing a modification example.

### DESCRIPTION OF THE EMBODIMENTS

Hereinafter, one embodiment of the disclosure will be described in detail using the figures.

### <Motor Device>

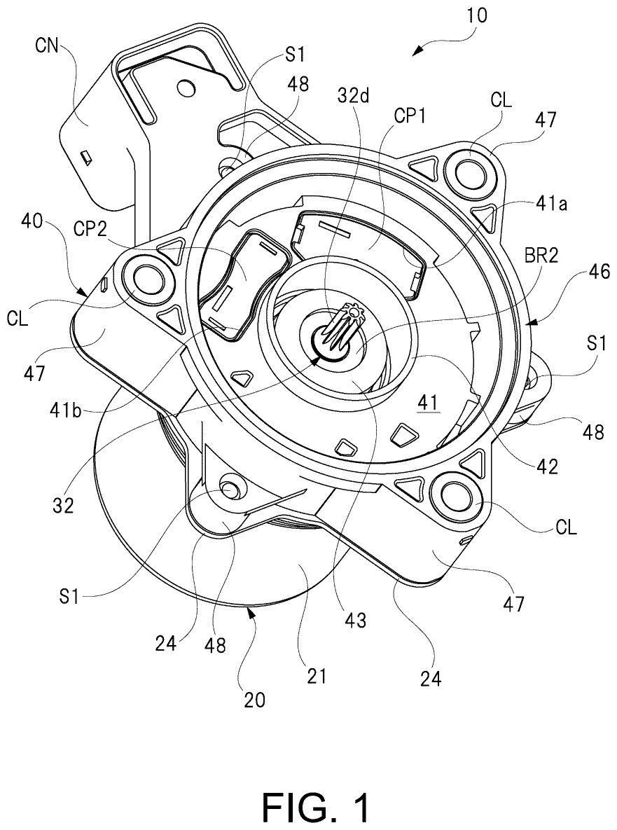

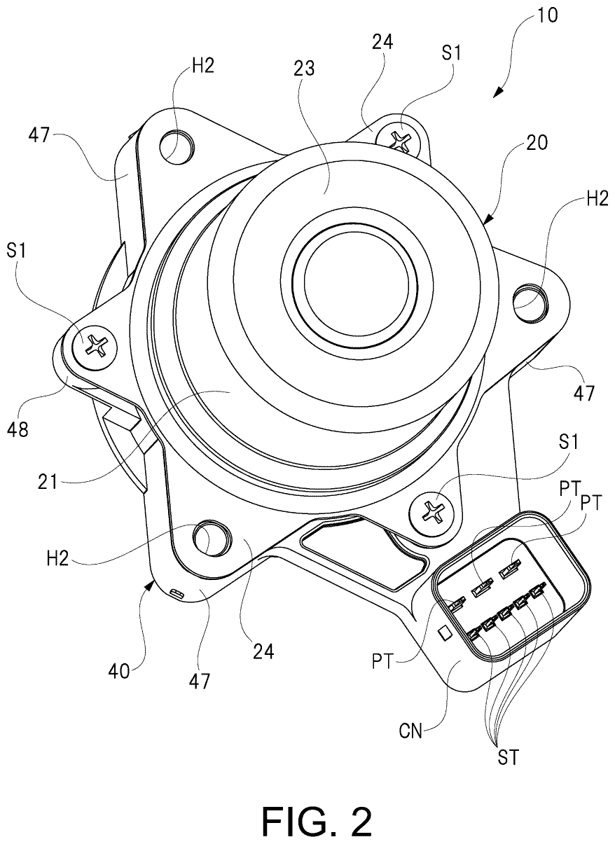

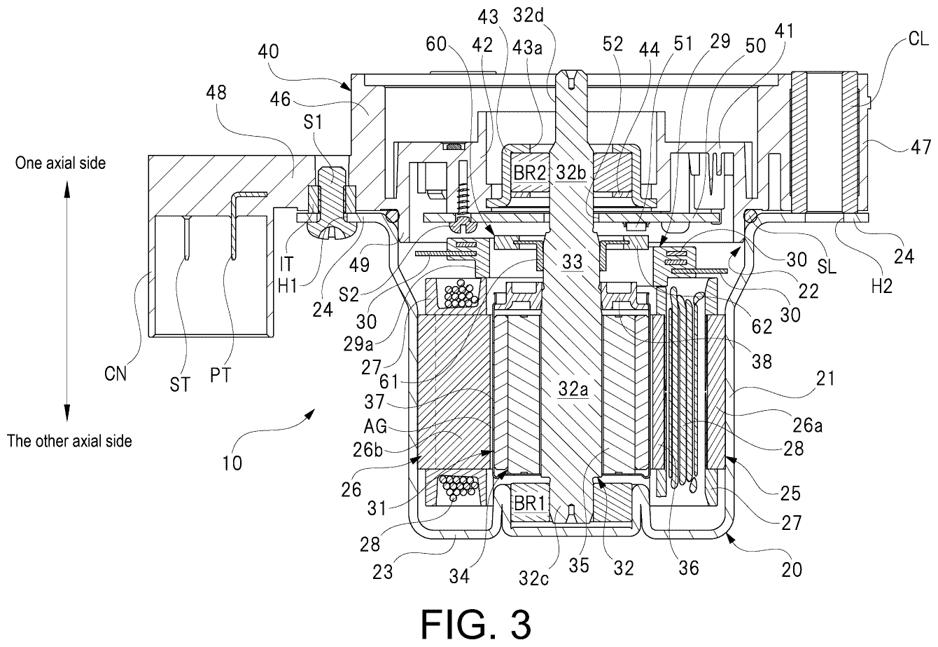

FIG. 1 is a perspective view of a motor device as viewed from the bracket side, FIG. 2 is a perspective view of the motor device as viewed from the case side, and FIG. 3 is a cross-sectional view showing the internal structure of the motor device.

The motor device 10 shown in FIG. 1 to FIG. 3 is used as a drive source for an electric brake device mounted in a vehicle such as an automobile. The motor device 10 is a brushless motor and includes a case 20 made of metal. The case 20 is formed into a bottomed cylindrical shape by deep drawing or other processing of a metal plate. The case 20 includes a cylindrical portion 21, and an opening portion 22 is provided on one axial side (upper side in FIG. 3) of the cylindrical portion 21. Further, a bottom wall portion 23 is provided on the other axial side (lower side in FIG. 3) of the cylindrical portion 21.

On the opening portion 22 side of the cylindrical portion 21, multiple flange portions 24 are provided to protrude to the radial outer side, and these flange portions 24 are attached to the other axial side (lower side in FIG. 3) of a bracket 40 made of resin by a total of three first male screw members S1. Each flange portion 24 is provided with a first insertion hole H1 through which the first male screw member S1 is inserted, and a second insertion hole H2 through which a fixing bolt (not shown) for fixing the motor device 10 to a driven object (such as an electric brake device) is inserted.

In this way, the opening portion 22 of the case 20 made of metal is closed by the bracket 40 made of resin. The first male screw member S1 is tightened on the tip side by a plus (+) screwdriver (not shown).

### <Stator>

As shown in FIG. 3, a stator (fixed element) 25 is housed inside the case 20. Specifically, the stator 25 is fixed to the radial inner side of the cylindrical portion 21 by press-fitting. The stator 25 includes a stator core 26 formed in an approximately cylindrical shape, and the stator core 26 is formed by laminating multiple thin steel plates. The stator core 26 includes a core body 26a formed in an approximately cylindrical shape, and multiple teeth 26b protruding to the radial inner side of the core body 26a.

Insulators 27 made of resin are respectively mounted on the multiple teeth 26b, and coils 28 composed of U-phase, V-phase, and W-phase are wound around the outer side of the insulators 27 with predetermined winding method and number of turns. That is, three-phase coils 28 are respectively wound around the multiple teeth 26b via the insulators 27 that function as insulating bodies. Then, the three-phase coils 28 are arranged alternately in the circumferential direction of the stator 25 as U-phase, V-phase, W-phase.

A ring-shaped bus bar unit 29 is mounted on one axial side (upper side in FIG. 3) of the stator 25. The bus bar unit 29 includes multiple conductive members 30 corresponding to U-phase, V-phase, and W-phase, and these conductive members 30 are held by a ring-shaped holding member 29a. The holding member 29a is made of an insulating body such as plastic, and prevents each of the conductive members 30 from short-circuiting.

Then, one end portion of each of the conductive members 30 is electrically connected to the end portion of the three-phase coils 28. On the other hand, the other end portion of each of the conductive members 30 is electrically connected to one end portion of a power terminal PT provided on the bracket 40.

Here, three power terminals PT are provided corresponding to U-phase, V-phase, and W-phase, and the other end portions of these power terminals PT are exposed inside a connector connecting portion CN to which a vehicle-side connector member (not shown) is connected.

### <Rotor>

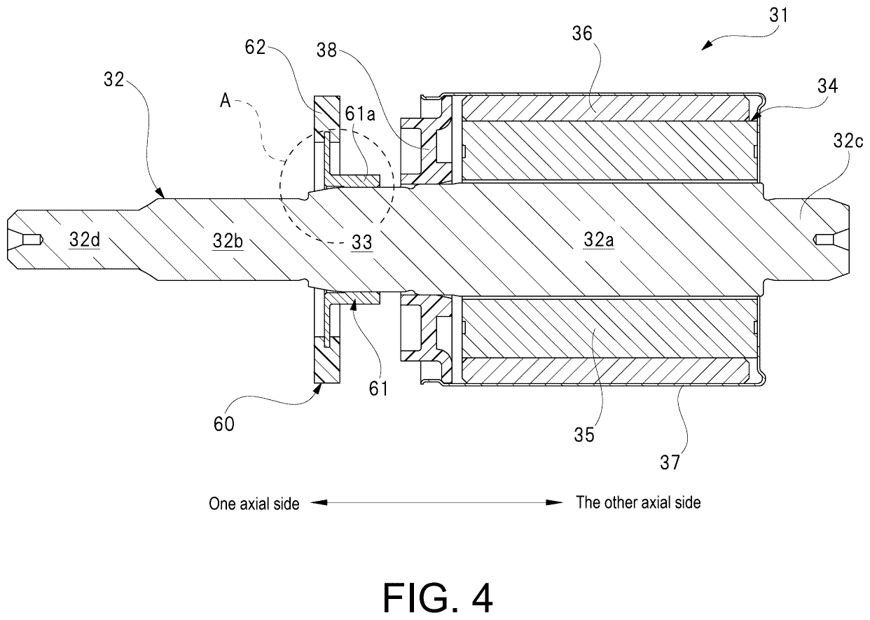

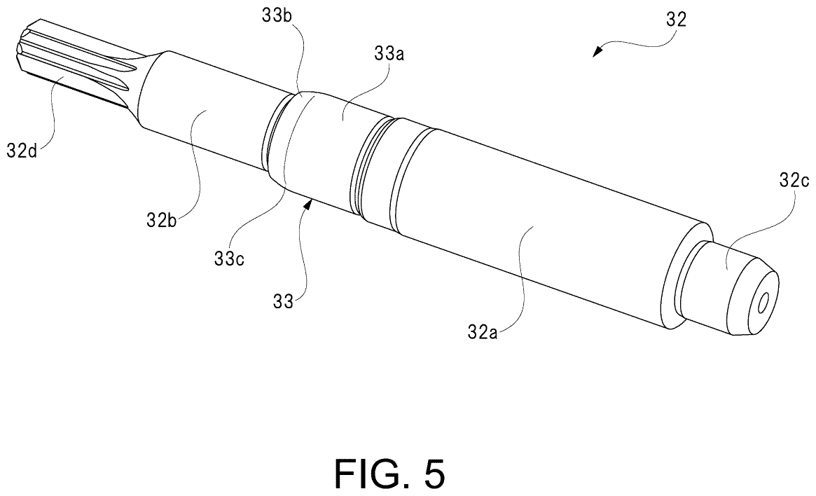

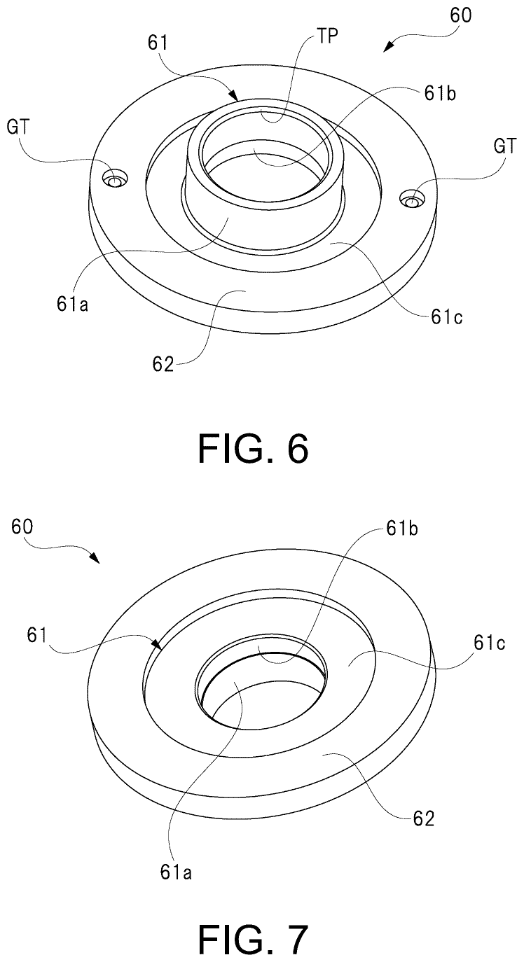

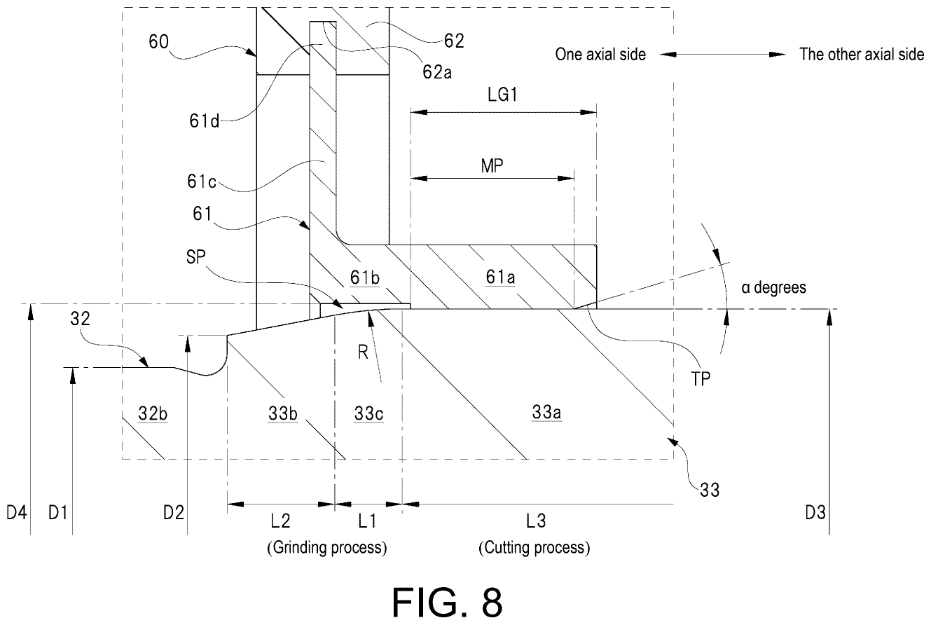

FIG. 4 is a cross-sectional view showing only the rotor of FIG. 3, FIG. 5 is a perspective view showing the rotation shaft alone, FIG. 6 is a perspective view of the magnet unit as viewed from the rotor body side, FIG. 7 is a perspective view of the magnet unit as viewed from the pinion gear portion side, and FIG. 8 is an enlarged cross-sectional view showing the fixed structure of the magnet unit to the rotation shaft.

As shown in FIG. 3 and FIG. 4, the motor device 10 includes a rotor (rotating element) 31 that rotates relative to the stator 25. The rotor 31 has a rotation shaft 32 and a rotor body 34.

### <Rotation Shaft>

As shown in FIG. 4 and FIG. 5, the rotation shaft 32 is made of machine structural alloy steel such as “SNCM420” that has undergone heat treatment such as carburizing, quenching, and tempering, and is formed into a stepped shape by performing a cutting process and a grinding process on the outer peripheral portion of a round steel bar (raw material). That is, the rotation shaft 32 is a cutting/grinding processed product, and the hardness (Vickers hardness) thereof is approximately “700 Hv”.

Specifically, the rotation shaft 32 includes a large diameter portion 32a, a medium diameter portion 33 that has a smaller diameter than the large diameter portion 32a, and a small diameter portion 32b that has a smaller diameter than the medium diameter portion 33. As shown in FIG. 3, the rotation shaft 32 passes through a through hole 52 provided in a sensor board 50 and is arranged to cross the bracket 40.

The large diameter portion 32a is arranged on the other axial side (right side in FIG. 5) of the rotation shaft 32, and occupies approximately half of the rotation shaft 32 in the axial direction. Then, a rotor core 35 that forms the rotor body 34 is fixed to the outer peripheral portion of the large diameter portion 32a by press-fitting. As a result, the rotation shaft 32 rotates together with the rotor core 35. A bearing support portion 32c is provided on the other axial side (right side in FIG. 5) of the large diameter portion 32a, and the bearing support portion 32c is rotatably supported by a first bearing BR1 (see FIG. 3).

In addition, the medium diameter portion 33 is arranged on one axial side (left side in FIG. 5) of the large diameter portion 32a, and the axial length thereof is approximately ¼ of the axial length of the large diameter portion 32a. Then, a magnet unit 60 (see FIG. 6 and FIG. 7) is fixed to the outer peripheral portion of the medium diameter portion 33. Here, the magnet unit 60 is used to detect the rotation state of the rotor 31 (rotation shaft 32), and rotates together with the rotation shaft 32.

Furthermore, the small diameter portion 32b is arranged on one axial side (left side in FIG. 5) of the medium diameter portion 33, and the axial length thereof is approximately 1.5 times the axial length of the medium diameter portion 33. Then, the small diameter portion 32b is rotatably supported by a second bearing BR2 (see FIG. 3). A pair of first bearing BR1 and second bearing BR2 that rotatably support both axial sides of the rotation shaft 32 are both ball bearings (not shown in detail).

Additionally, a pinion gear portion 32d that forms the output portion of the motor device 10 is integrally provided on one axial side (left side in FIG. 5) of the small diameter portion 32b. Specifically, the pinion gear portion 32d is, for example, connected in a power transmittable manner to a feed screw shaft (not shown) that advances and retracts the piston of the electric brake device.

### <Medium Diameter Portion>

The medium diameter portion 33 to which the magnet unit 60 is fixed has, as shown in FIG. 8, a columnar portion 33a, a tapered portion 33b, and an arc-shaped connecting portion 33c. Specifically, the columnar portion 33a extends straight with a constant outer diameter in the axial direction of the rotation shaft 32, and is the portion with the largest outer diameter in the medium diameter portion 33. Then, a cylindrical body portion 61a of a holder member 61 that forms the magnet unit 60 is fixed to the columnar portion 33a by press-fitting.

The columnar portion 33a corresponds to the straight portion in the disclosure.

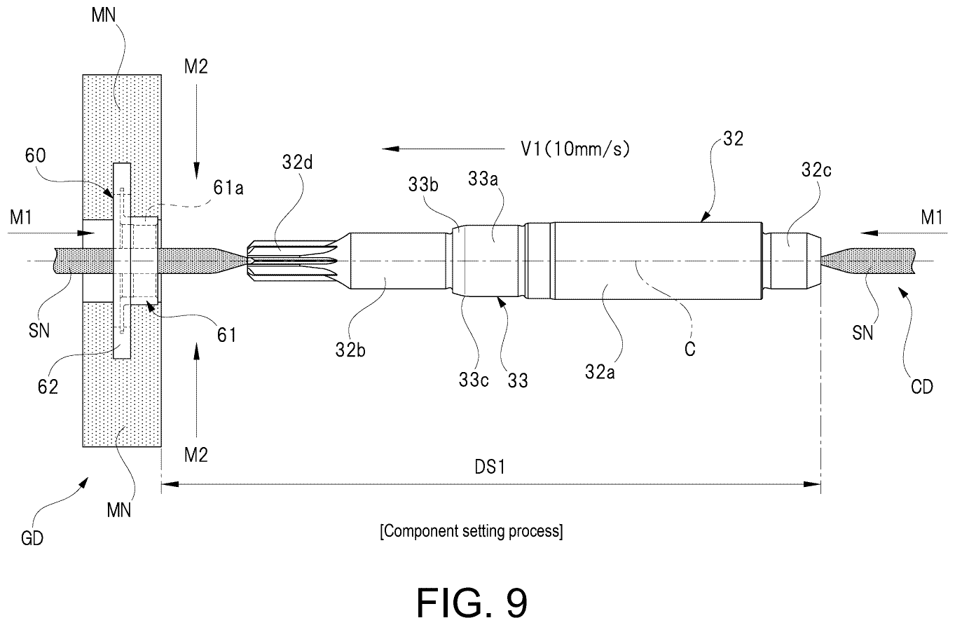

In addition, the tapered portion 33b is provided on one axial side (left side in FIG. 8) of the columnar portion 33a, and the outer diameter gradually decreases as the tapered portion 33b extends away from the columnar portion 33a. Specifically, the tapered portion 33b has a truncated cone shape whose cross-sectional area in the direction perpendicular to the axial direction of the rotation shaft 32 gradually decreases toward one axial side (left side in FIG. 8) of the rotation shaft 32. The magnet unit 60 is press-fitted to the columnar portion 33a from one axial side of the tapered portion 33b (see FIG. 9 to FIG. 11).

Furthermore, the arc-shaped connecting portion 33c is provided between the columnar portion 33a and the tapered portion 33b in the axial direction of the rotation shaft 32. Specifically, as shown in FIG. 8, when viewed from the radial outer side of the rotation shaft 32, the outer peripheral portion of the arc-shaped connecting portion 33c is formed in an arc shape with a radius dimension R. Here, the arc-shaped connecting portion 33c has a function of smoothly connecting the columnar portion 33a and the tapered portion 33b without any step therebetween in the axial direction of the rotation shaft 32. In other words, the arc-shaped connecting portion 33c connects the outer peripheral surface of the columnar portion 33a and the outer peripheral surface of the tapered portion 33b with an arc surface. This makes it possible to easily press-fit the magnet unit 60 to the columnar portion 33a from one axial side of the tapered portion 33b (see FIG. 9 to FIG. 11).

The arc-shaped connecting portion 33c corresponds to the connecting portion in the disclosure.

Here, the small diameter portion 32b is arranged on one axial side (left side in FIG. 8) of the tapered portion 33b. The outer diameter dimension D1 of the small diameter portion 32b is smaller than the outer diameter dimension D2 on one axial side of the tapered portion 33b (D1<D2).

Further, the length dimension L1 of the arc-shaped connecting portion 33c in the axial direction of the rotation shaft 32 is shorter than the length dimension L2 of the tapered portion 33b in the axial direction of the rotation shaft 32 (L1<L2). Furthermore, the length dimension L3 of the columnar portion 33a in the axial direction of the rotation shaft 32 is longer than the length dimension L2 of the tapered portion 33b in the axial direction of the rotation shaft 32 (L3>L2). In other words, the relationship between the length dimensions L1 to L3 becomes “L1<L2<L3” in terms of magnitude.

Also, as shown in FIG. 8, the inner peripheral surface of the cylindrical body portion 61a that forms the holder member 61 is in contact with the outer peripheral surface of the columnar portion 33a throughout the entire region in the axial direction. In other words, the inner peripheral surface (fitting portion MP) of the cylindrical body portion 61a is arranged within the range of the columnar portion 33a in the axial direction. This makes it possible to sufficiently secure the fixing strength of the magnet unit 60 to the rotation shaft 32.

Furthermore, within the range in the axial direction of a gap-forming cylindrical portion 61b that forms the holder member 61, the entire region in the axial direction of the arc-shaped connecting portion 33c and a part of the other axial side (right side in FIG. 8) of the tapered portion 33b are arranged. In other words, in the radial direction of the rotation shaft 32, the entire arc-shaped connecting portion 33c and a part of the tapered portion 33b overlap with the gap-forming cylindrical portion 61b of the holder member 61.

Here, the shape of the columnar portion 33a is adjusted by a “cutting process”. In contrast, the shapes of the tapered portion 33b and the arc-shaped connecting portion 33c are adjusted by a “grinding process”. That is, the outer peripheral surfaces of the tapered portion 33b and the arc-shaped connecting portion 33c are more smoothed than the outer peripheral surface of the columnar portion 33a. This makes it easy to press-fit the rotation shaft 32 into the holder member 61 while making it difficult for the holder member 61 to come off from the rotation shaft 32.

### <Rotor Body>

Furthermore, as shown in FIG. 3 and FIG. 4, the rotor body 34 fixed to the outer peripheral portion of the large diameter portion 32a includes a rotor core 35 formed in an approximately cylindrical shape by laminating multiple thin steel plates (ferromagnetic material), and a cylindrical magnet 36 mounted on the radial outer side of the rotor core 35. Then, the radial outer side of the magnet 36 is covered by a cylindrical magnet cover 37 made of a stainless steel plate or the like.

The magnet cover 37 is fixed to the outer peripheral portion of the magnet 36 by crimping one axial side (left side in FIG. 4) of the magnet cover 37 radially inward. This allows the rotation center of the magnet 36 and the rotation center of the rotor core 35 to be accurately matched, thereby suppressing rotation wobble of the rotor 31. In addition, an air gap AG (see FIG. 3) between the rotor body 34 and the stator 25 can be narrowed, making it possible to realize a compact and high-output (high-efficiency) motor device 10.

In order to suppress the crimping force of the magnet cover 37 from being transmitted to the magnet 36, a magnet protection member 38 made of a resin material such as plastic is provided on the other axial side of the magnet cover 37.

Here, the motor device 10 is not limited to the surface permanent magnet type where the magnet 36 is mounted on the surface of the rotor core 35 as described above, but may also be an interior permanent magnet type where the magnet is embedded inside the rotor core.

### <Bracket>

As shown in FIG. 1 and FIG. 3, the bracket 40 has a function of fixing the motor device 10 to the driven object. The bracket 40 is formed in an approximately disc shape by injection molding of a molten resin material such as plastic. That is, the bracket 40 is an injection molded product.

The bracket 40 includes a partition wall portion 41 formed in an approximately disc shape. The partition wall portion 41 separates the case 20 side (lower side in FIG. 3) from the driven object side (upper side in FIG. 3) in the axial direction of the rotation shaft 32, and an insertion cylindrical portion 42 is integrally provided at the central portion of the partition wall portion 41, through which the other axial side (upper side in FIG. 3) of the rotation shaft 32 is inserted.

Also, on the radial inner side of the insertion cylindrical portion 42, a bearing holder 43 formed in an approximately cup shape by press processing or the like of a steel plate is provided. Specifically, the radial outer side of the bearing holder 43 is fixed to the radial inner side of the insertion cylindrical portion 42.

Then, an insertion hole 43a through which the rotation shaft 32 is inserted is provided in the bearing holder 43, and the bearing holder 43 holds the second bearing BR2 so as to be coaxial with the insertion cylindrical portion 42. An annular fixing plate 44 is provided on the other axial side (lower side in FIG. 3) of the second bearing BR2 to prevent the second bearing BR2 from falling out of the bearing holder 43.

Furthermore, the sensor board 50 is provided on the other axial side (lower side in FIG. 3) of the insertion cylindrical portion 42. Specifically, the sensor board 50 is fixed to the case 20 side of the partition wall portion 41 by multiple second male screw members S2.

In addition, as shown in FIG. 1, the partition wall portion 41 is provided with a first terminal hole 41a in which one end portion of each of a total of three power terminals PT (see FIG. 2) is arranged inside, and a second terminal hole 41b in which one end portion of each of a total of five sensor terminals ST (see FIG. 2) is arranged inside. Then, a first cap CP1 and a second cap CP2 are respectively mounted to the first terminal hole 41a and the second terminal hole 41b to cover the power terminals PT and the sensor terminals ST.

Furthermore, as shown in FIG. 1 and FIG. 3, a cylindrical wall portion 46 having a larger diameter than the insertion cylindrical portion 42 is provided on the radial outer side of the insertion cylindrical portion 42. Specifically, the cylindrical wall portion 46 is arranged on the outer peripheral portion of the partition wall portion 41.

The cylindrical wall portion 46 is arranged coaxially with the insertion cylindrical portion 42 and extends in the axial direction of the rotation shaft 32. Further, a total of three driven object fixing portions 47 are integrally provided on the cylindrical wall portion 46. Cylindrical collars CL made of metal are provided on these driven object fixing portions 47. This makes it possible to firmly fix the motor device 10 to the driven object without damaging the driven object fixing portions 47 made of resin.

The driven object fixing portions 47 are arranged at predetermined intervals in the circumferential direction of the cylindrical wall portion 46, and protrude to the radial outer side of the cylindrical wall portion 46 when the bracket 40 is viewed from the other axial side (case 20 side). In addition, fixing bolts for fixing the motor device 10 to the driven object are inserted through the collars CL held in the driven object fixing portions 47.

Furthermore, the connector connecting portion CN is integrally provided on the radial outer side of the cylindrical wall portion 46. The connector connecting portion CN is formed in an approximately rectangular parallelepiped shape, and a vehicle-side connector member can be connected from the other axial side (lower side in FIG. 3) of the cylindrical wall portion 46.

Additionally, a total of three case fixing portions 48 are integrally provided on the cylindrical wall portion 46. These case fixing portions 48 are portions where the flange portions 24 of the case 20 are fixed, and each holds a cylindrical female screw member IT made of a steel material (see FIG. 3). Then, the first male screw members S1 for fixing the case 20 to the bracket 40 are respectively screwed into these female screw members IT.

The total of three case fixing portions 48 are arranged at predetermined intervals in the circumferential direction of the cylindrical wall portion 46, and the case fixing portions 48 are provided between adjacent driven object fixing portions 47. In addition, each of the case fixing portions 48 protrudes to the radial outer side of the cylindrical wall portion 46 when the bracket 40 is viewed from the other axial side (case 20 side).

Furthermore, as shown in FIG. 3, a fitting cylindrical portion 49 is integrally provided on the other axial side (case 20 side) of the bracket 40, and between the insertion cylindrical portion 42 and the cylindrical wall portion 46 in the radial direction of the bracket 40.

The fitting cylindrical portion 49 is a portion fitted to the opening portion 22 of the case 20, and an annular seal SL made of an elastic material such as rubber is mounted on the radial outer side thereof. The annular seal SL seals between the bracket 40 and the case 20.

### <Sensor Board>

As shown in FIG. 3, the sensor board 50 fixed to the bracket 40 is arranged in the axial direction of the rotation shaft 32 between the second bearing BR2 and an annular magnet 62 of the magnet unit 60. Then, a total of three Hall elements 51 (only one is shown in the figure) are mounted on the sensor board 50. Specifically, the total of three Hall elements 51 are provided corresponding to U-phase, V-phase, and W-phase, and are arranged around the through hole 52 provided at the central portion of the sensor board 50.

Here, the total of three Hall elements 51 are configured to detect changes in the magnetic poles of the annular magnet 62 in response to the rotation of the rotation shaft 32. In other words, the Hall elements 51 detect the rotation state of the annular magnet 62. Also, one end portion of each of the total of five sensor terminals ST is electrically connected to the sensor board 50. The other end portion of each of the total of five sensor terminals ST are exposed inside the connector connecting portion CN to which the vehicle-side connector member is connected (see FIG. 2 and FIG. 3).

### <Magnet Unit>

As shown in FIG. 4 and FIG. 6 to FIG. 8, the magnet unit 60 includes the holder member 61 and the annular magnet 62. The holder member 61 is made of, for example, free-cutting brass “C3604”, and is formed into a cylindrical shape with a flange and a step by a cutting process. In other words, the holder member 61 is a cutting processed product, and the hardness (Vickers hardness) thereof is approximately “131 Hv”.

That is, the rotation shaft 32 to which the magnet unit 60 is fitted has a hardness (about 700 Hv) higher than the hardness (about 131 Hv) of the holder member 61.

The holder member 61 includes the cylindrical body portion 61a. The cylindrical body portion 61a is provided to protrude on the other axial side (right side in FIG. 8) of the annular magnet 62, and extends in the axial direction of the rotation shaft 32. The cylindrical body portion 61a is fixed to the columnar portion 33a of the medium diameter portion 33 by press-fitting, and the axial length thereof is LG1.

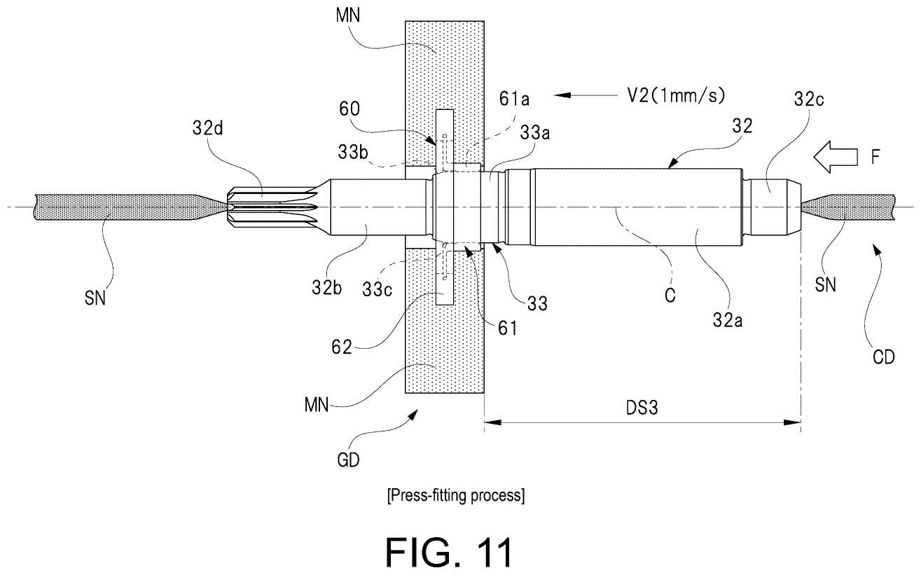

Further, the inner diameter dimension D3 of the cylindrical body portion 61a is slightly larger than the outer diameter dimension of the columnar portion 33a. As a result, the cylindrical body portion 61a can be press-fitted to the columnar portion 33a by a predetermined pressing force F (see FIG. 11). Here, the axial length LG1 of the cylindrical body portion 61a is smaller than the length dimension L3 of the columnar portion 33a (LG1<L3).

In addition, at the end portion on the other axial side (right side in FIG. 8) of the cylindrical body portion 61a, a mounting guide tapered surface TP is provided to guide the insertion operation of the rotation shaft 32. Specifically, the mounting guide tapered surface TP is provided on the radial inner side of the cylindrical body portion 61a, and is formed to gradually increase the opening area of the cylindrical body portion 61a as the mounting guide tapered surface TP extends toward the other axial side of the cylindrical body portion 61a. And, the mounting guide tapered surface TP has an angle of a degrees on the acute angle side with respect to the axis line C of the rotation shaft 32 (see FIG. 9), which is about 20 degrees and not more than 45 degrees.

This makes it possible to easily align (center) the axis line C of the rotation shaft 32 inserted into the cylindrical body portion 61a with the center of the cylindrical body portion 61a. That is, the mounting guide tapered surface TP has a function of guiding the mounting of the columnar portion 33a to the cylindrical body portion 61a.

Here, if the angle on the acute angle side of the mounting guide tapered surface TP with respect to the axis line C of the rotation shaft 32 is increased (for example, made larger than 45 degrees), the rotation shaft 32 becomes more likely to catch on the mounting guide tapered surface TP. This may reduce the assembly workability of the motor device 10. Therefore, in the present embodiment, the angle of the mounting guide tapered surface TP is set to a degrees (about 20 degrees), so that the rotation shaft 32 is less likely to catch on the cylindrical body portion 61a, making it possible to quickly center both components with each other (improving assembly workability).

The holder member 61 corresponds to the fixing component in the disclosure, and the cylindrical body portion 61a corresponds to the press-fitting cylindrical portion in the disclosure.

In addition, the holder member 61 includes the gap-forming cylindrical portion 61b. Specifically, the gap-forming cylindrical portion 61b is provided in alignment on one axial side (left side in FIG. 8) of the cylindrical body portion 61a, and overlaps with a part of the tapered portion 33b and the entire arc-shaped connecting portion 33c in the radial direction of the rotation shaft 32. And, the inner diameter dimension D4 of the gap-forming cylindrical portion 61b is larger than the inner diameter dimension D3 of the cylindrical body portion 61a (D4>D3). Therefore, in the radial direction of the rotation shaft 32, an annular gap SP is formed between the gap-forming cylindrical portion 61b, and the tapered portion 33b and the arc-shaped connecting portion 33c.

Here, with the annular gap SP provided on the radial inner side of the gap-forming cylindrical portion 61b, even if “burrs (cutting chips)” are generated during press-fitting of the rotation shaft 32 into the holder member 61, the burrs would be small and can be contained within the annular gap SP. Additionally, by providing the annular gap SP, during press-fitting of the rotation shaft 32 into the cylindrical body portion 61a, the transmission of strain to a flange portion 61c that holds the annular magnet 62 is suppressed. Therefore, no strain occurs in the annular magnet 62.

The flange portion 61c is integrally provided on one axial side (left side in FIG. 8) and on the radial outer side of the gap-forming cylindrical portion 61b. The flange portion 61c is provided to protrude to the radial outer side of the gap-forming cylindrical portion 61b and is formed in an approximately disc shape. Then, an outer peripheral end portion 61d of the flange portion 61c extends into an inner peripheral recessed portion 62a of the annular magnet 62. During injection molding of the annular magnet 62, the holder member 61 and the annular magnet 62 are integrated.

Specifically, the annular magnet 62 is a so-called plastic magnet made by mixing plastic with a magnetic raw material, and is formed into an approximately annular shape by injection molding using a mold. Thus, the annular magnet 62 is an injection molded product, and as shown in FIG. 6, a pair of gate marks GT are formed on the annular magnet 62.

In this way, the holder member 61 holds the annular magnet 62 which is used to detect the rotation state of the rotation shaft 32. The annular magnet 62 corresponds to the sensor magnet in the disclosure.

### <Assembly Procedure>

Next, the mounting procedure (assembly procedure) of the magnet unit 60 to the rotation shaft 32 will be described in detail using the figures.

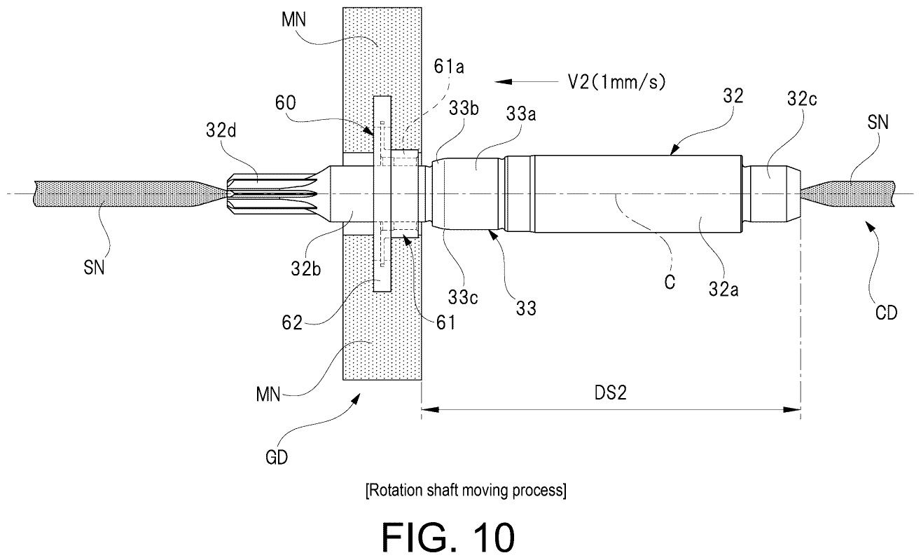

FIG. 9 is an assembly explanatory view showing a [component setting process], FIG. 10 is an assembly explanatory view showing a [rotation shaft moving process], and FIG. 11 is an assembly explanatory view showing a [press-fitting process].

[Component Setting Process]

First, as shown in FIG. 9, the rotation shaft 32 and the magnet unit 60, which are manufactured in separate manufacturing processes, are prepared.

Next, the rotation shaft 32 is set in a transport device CD. Specifically, the transport device CD has a pair of shaft holding members SN that hold the rotation shaft 32 from both axial sides, as indicated by arrow M1, and these shaft holding members SN are capable of moving in the axial direction of the rotation shaft 32 while holding the rotation shaft 32. That is, the transport device CD has a function of transporting the rotation shaft 32 in the axial direction thereof.

Further, the magnet unit 60 is set in a gripping device GD. Specifically, the gripping device GD has a pair of unit holding members MN that hold the magnet unit 60 from the radial outer side thereof from a direction perpendicular to the axial direction of the rotation shaft 32, as indicated by arrow M2. The pair of unit holding members MN have a function of arranging the magnet unit 60 on the axis line C of the rotation shaft 32 while holding the magnet unit 60. The pair of unit holding members MN are unable to move in the axial direction of the rotation shaft 32.

Then, as shown in FIG. 9, in the state where the rotation shaft 32 is set in the transport device CD and the magnet unit 60 is set in the gripping device GD, that is, in the standby state, the distance between the end portion on the other axial side of the rotation shaft 32 and the end portion on the other axial side of the gripping device GD is a set distance DS1. Therefore, each component (the rotation shaft 32 and the magnet unit 60) can be easily set individually.

This completes the [component setting process]. Subsequently, the transport device CD is driven at a feed speed V1 (10 mm/s), and the rotation shaft 32 is moved toward the magnet unit 60.

### <Rotation Shaft Moving Process>

Here, as shown in FIG. 9, the rotation shaft 32 is moved at a relatively fast feed speed V1 (10 mm/s) until the rotation shaft 32 is brought close to the magnet unit 60 and the columnar portion 33a of the medium diameter portion 33 is press-fitted into the cylindrical body portion 61a of the holder member 61. Then, as shown in FIG. 10, when the distance between the end portion on the other axial side of the rotation shaft 32 and the end portion on the other axial side of the gripping device GD becomes a pre-press-fitting distance DS2 (DS2<DS1), the transport device CD automatically sets the feed speed to V2 (1 mm/s).

Specifically, as shown in FIG. 10, when the cylindrical body portion 61a is positioned close to the medium diameter portion 33 of the small diameter portion 32b of the rotation shaft 32, the feed speed is reduced to V2, which is 1/10 of the feed speed V1. This allows the rotation shaft 32 to be quickly moved to the stage immediately before press-fitting into the cylindrical body portion 61a.

This completes the [Rotation Shaft Moving Process]. Subsequently, the procedure proceeds to the [press-fitting process] of FIG. 11.

### <Press-Fitting Process>

As shown in FIG. 11, the transport device CD is maintained at a constant feed speed V2 (1 mm/s), and is driven to generate a relatively large pressing force F to enable press-fitting of the columnar portion 33a into the cylindrical body portion 61a. Then, the cylindrical body portion 61a is fitted to the columnar portion 33a of the medium diameter portion 33 through the tapered portion 33b and the arc-shaped connecting portion 33c (see FIG. 8) of the medium diameter portion 33. At this time, the medium diameter portion 33 is guided by the mounting guide tapered surface TP (see FIG. 8) of the cylindrical body portion 61a to be smoothly fitted to the cylindrical body portion 61a.

Subsequently, when the distance between the end portion on the other axial side of the rotation shaft 32 and the end portion on the other axial side of the gripping device GD becomes a press-fitting completion distance DS3 (DS3<DS2), the transport device CD automatically stops.

Therefore, the magnet unit 60 is positioned at a predetermined position in the axial direction with respect to the rotation shaft 32. This completes the [press-fitting process], and the fixing operation of the magnet unit 60 to the rotation shaft 32 is finished.

### <Comparative Verification of Burr Occurrence Condition>

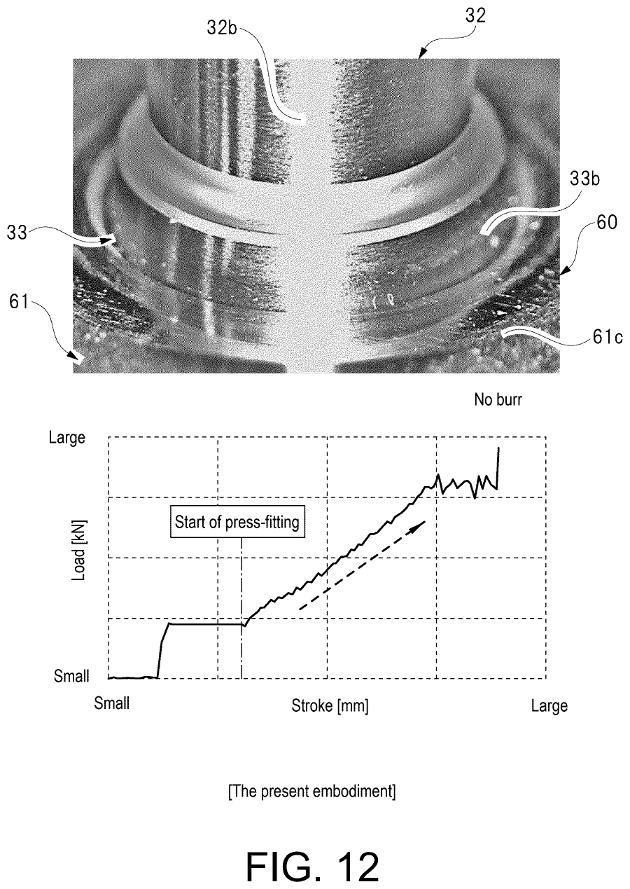

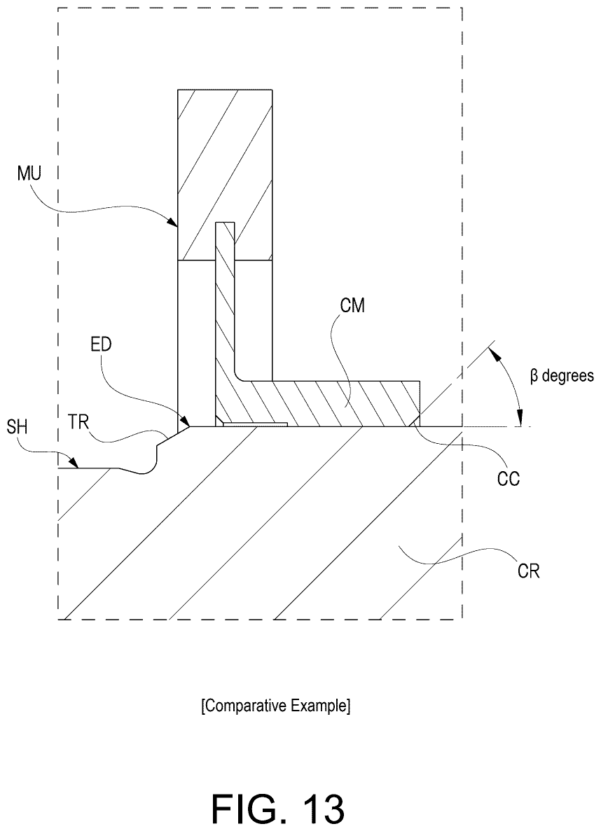

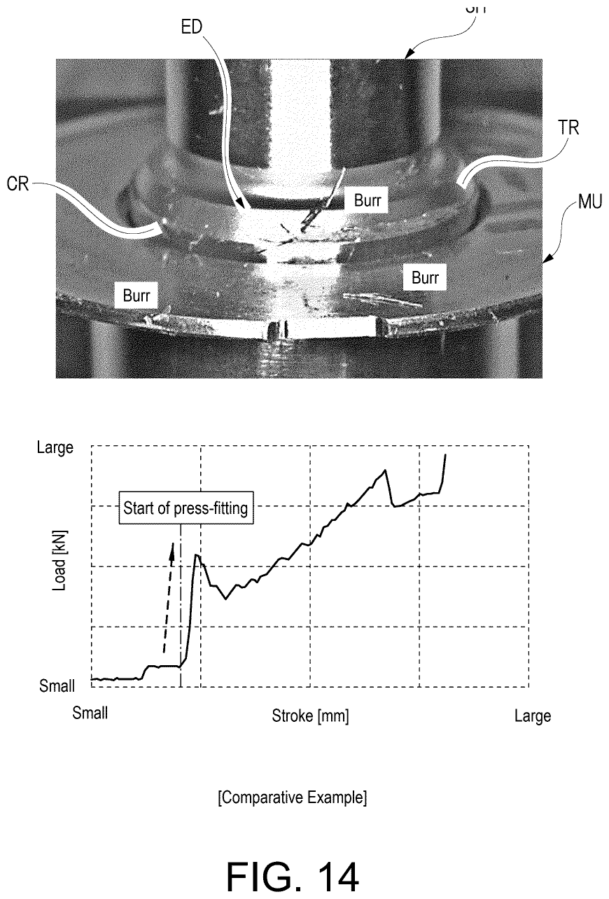

FIG. 12 is a view illustrating the assembled state of the present embodiment, FIG. 13 is a view corresponding to FIG. 8, showing a comparative example, and FIG. 14 is a view illustrating the assembled state of the comparative example. The enlarged photographs in the upper sections of FIG. 12 and FIG. 14 show the press-fitted location (fitted portion) between the rotation shaft and the magnet unit, as viewed from one axial side.

As shown in the enlarged photograph in the upper section of FIG. 12, no so-called “burr (cutting chip)” was found in the rotation shaft 32 and the magnet unit 60 according to the present embodiment. That is, the assembled state of the present embodiment was good, and it was confirmed that the subsequent deburring operation was unnecessary.

This is attributed to the fact that, as shown in the graph in the lower section of FIG. 12, from the “start of press-fitting” of the medium diameter portion 33 to the cylindrical body portion 61a (see FIG. 8), the load [kN] increases relatively gradually as indicated by the dashed arrow with the increase in stroke [mm] of the rotation shaft 32 relative to the magnet unit 60. Specifically, due to the function of the arc-shaped connecting portion 33c (see FIG. 8) provided on the rotation shaft 32 by a grinding process, the cylindrical body portion 61a is deformed to gradually expand in diameter without the inner peripheral portion of the cylindrical body portion 61a being cut.

Even if some burrs occur, the burrs are small and remain in the annular gap SP between the gap-forming cylindrical portion 61b of the holder member 61 and the medium diameter portion 33 of the rotation shaft 32. Therefore, the subsequent deburring operation is unnecessary.

A structure close to the conventional fixed structure was prepared as a comparative example for observing the occurrence condition of burrs. Here, as shown in FIG. 13, the rotation shaft SH of the comparative example (Vickers hardness: 700 Hv) has a tapered portion TR and a columnar portion CR, but there is no arc-shaped connecting portion between the tapered portion TR and the columnar portion CR in the axial direction of the rotation shaft SH, and an edge ED exists instead. Also, on the other axial side (right side in FIG. 13) of the cylindrical body portion CM (Vickers hardness: 131 Hv) of the magnet unit MU, an annular C chamfered portion CC with an angle of β degrees (45 degrees) is provided.

As shown in the enlarged photograph in the upper section of FIG. 14, in the comparative example, multiple relatively large burrs that are visible to the naked eyes occurred. In other words, it was found that the subsequent deburring operation is necessary in the comparative example.

This is because, as shown in the graph in the lower section of FIG. 14, the edge ED of the rotation shaft SH is pressed against the inner peripheral portion of the cylindrical body portion CM with a strong force, and as the stroke [mm] of the rotation shaft SH relative to the magnet unit MU increases, the load [kN] increases rapidly as indicated by the dashed arrow. As a result, the inner peripheral portion of the cylindrical body portion CM is cut by the edge ED, which leads to the occurrence of multiple relatively large burrs.

Furthermore, the annular C chamfered portion CC with an angle of β degrees (45 degrees) provided on the other axial side of the cylindrical body portion CM has an inferior centering function for the rotation shaft SH compared to the mounting guide tapered surface TP (α degrees=about 20 degrees) of the present embodiment. Therefore, the edge ED gets caught on the C chamfered portion CC, which also causes the occurrence of burrs.

### Modification Example

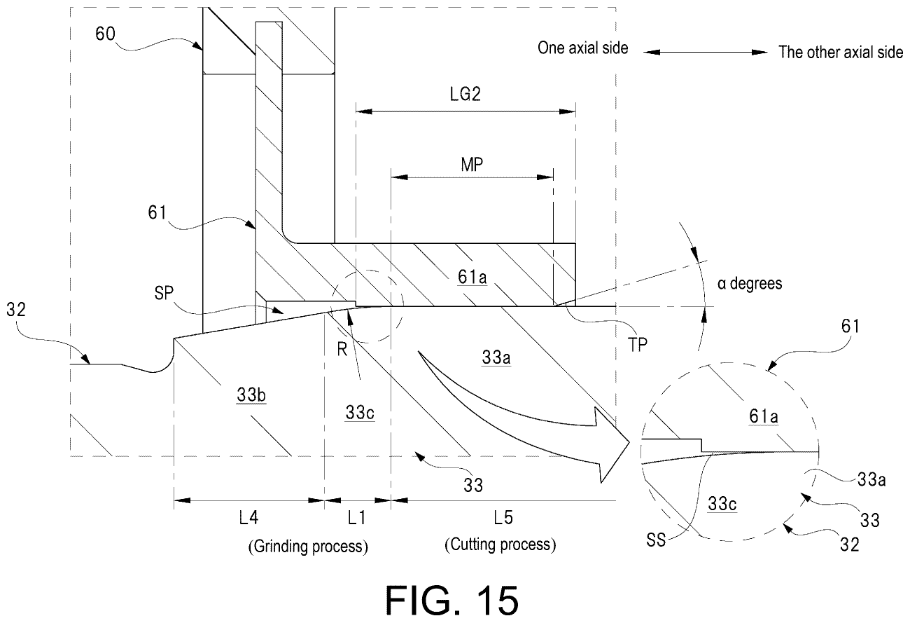

The fixed structure of the magnet unit 60 to the rotation shaft 32 can also be configured as in the modification example shown in FIG. 15.

FIG. 15 is a view corresponding to FIG. 8, showing a modification example. The following description will focus only on the parts that differ from FIG. 8. The same reference symbols are assigned to parts having the same functions as in FIG. 8, and detailed descriptions thereof are omitted.

As shown in FIG. 15, in the modification example, the length dimension L4 of the tapered portion 33b forming the medium diameter portion 33 is longer than the length dimension L2 of the tapered portion 33b shown in FIG. 8 (L4>L2), and the length dimension L5 of the columnar portion 33a is shorter than the length dimension L3 of the columnar portion 33a shown in FIG. 8 (L5<L3).

In addition, the axial length LG2 of the cylindrical body portion 61a forming the holder member 61 is longer than the axial length LG1 of the cylindrical body portion 61a shown in FIG. 8 (LG2>LG1), and the cylindrical body portion 61a is opposed to a part of the columnar portion 33a and the arc-shaped connecting portion 33c in the radial direction of the rotation shaft 32.

As a result, as indicated by the dashed circle (enlarged view) in FIG. 15, a minute gap SS is formed between the cylindrical body portion 61a and the arc-shaped connecting portion 33c in the radial direction of the rotation shaft 32. The fitting portion MP between the cylindrical body portion 61a and the columnar portion 33a is made equivalent to that in FIG. 8 by increasing the axial length LG2 of the cylindrical body portion 61a. In other words, the fixing strength of the magnet unit 60 to the rotation shaft 32 is the same in both the embodiment shown in FIG. 8 and the modification example shown in FIG. 15.

Here, in the modification example shown in FIG. 15, the minute gap SS is formed between the cylindrical body portion 61a and the arc-shaped connecting portion 33c in the state where the magnet unit 60 is fixed at the predetermined position of the rotation shaft 32. As a result, even if burrs occur due to cutting of the inner peripheral portion of the cylindrical body portion 61a, it is not necessary to separate the generated burrs from the inner peripheral portion of the cylindrical body portion 61a. In other words, the generated burrs can remain connected to the inner peripheral portion of the cylindrical body portion 61a.

Therefore, compared to the embodiment shown in FIG. 8, it is possible to more reliably keep the generated burrs within the annular gap SP between the gap-forming cylindrical portion 61b and the medium diameter portion 33.

As described in detail above, according to the present embodiment, the rotation shaft 32 includes the columnar portion 33a in which the outer diameter is constant toward the axial direction of the rotation shaft 32, the tapered portion 33b which is provided on one axial side of the columnar portion 33a and in which the outer diameter decreases as the tapered portion 33b extends away from the columnar portion 33a, and the arc-shaped connecting portion 33c which is provided between the columnar portion 33a and the tapered portion 33b. The arc-shaped connecting portion 33c connects the outer peripheral surface of the columnar portion 33a and the outer peripheral surface of the tapered portion 33b with an arc surface when viewed from the radial outer side of the rotation shaft 32. The holder member 61 includes the cylindrical body portion 61a into which the columnar portion 33a is press-fitted, and the gap-forming cylindrical portion 61b which is provided on one axial side of the cylindrical body portion 61a and which forms the gap SP with the arc-shaped connecting portion 33c in the radial direction of the rotation shaft 32.

As a result, during the press-fitting of the columnar portion 33a into the cylindrical body portion 61a, the effect of the arc-shaped connecting portion 33c can gradually increase the load as the stroke of the rotation shaft 32 relative to the magnet unit 60 increases. Therefore, the occurrence of burrs (cutting chips) can be suppressed, which eliminates the need for the subsequent deburring operation and simplifies the manufacturing process. Even if burrs do occur, the burrs can be kept within the gap SP between the gap-forming cylindrical portion 61b and the medium diameter portion 33, making it possible to eliminate the need for the subsequent deburring operation.

Furthermore, according to the present embodiment, the rotation shaft 32 has a hardness higher than the hardness of the holder member 61. Therefore, even if burrs occur, the rotation shaft 32 is not cut, but rather the holder member 61 is the one that gets cut, which can minimize disruption to the rotational balance of the rotation shaft 32. Additionally, even if burrs occur, the holder member 61 is the one that gets cut, so the burrs can be reliably guided into the gap SP.

Additionally, according to the present embodiment, the mounting guide tapered surface TP is provided at the axial end portion of the cylindrical body portion 61a to guide the mounting of the columnar portion 33a into the cylindrical body portion 61a. Therefore, it is possible to smoothly mount the columnar portion 33a to the cylindrical body portion 61a. This also makes it possible to further suppress the occurrence of burrs.

Furthermore, according to the present embodiment, the mounting guide tapered surface TP has an angle α of about 20 degrees and not more than 45 degrees on the acute angle side with respect to the axis line C of the rotation shaft 32, so the axis line C of the rotation shaft 32 can be easily aligned (centered) with the center of the cylindrical body portion 61a without gouging each other. Therefore, both components can be assembled without catching each other, which also makes it possible to further suppress the occurrence of burrs.

In addition, according to the present embodiment, the fixed component that is fixed to the rotation shaft 32 is the holder member 61 that holds the annular magnet 62 used to detect the rotation state of the rotation shaft 32, and it is possible to suppress the occurrence of burrs in the holder member 61. Therefore, it is possible to sufficiently secure the fixing strength of the holder member 61 (annular magnet 62) to the rotation shaft 32, and to accurately match the axes of both components. As a result, the sensing accuracy can be improved.

Furthermore, according to the present embodiment, the subsequent deburring operation can be eliminated, so it becomes possible to achieve energy conservation in the manufacturing of the motor device 10. This makes it possible to achieve particularly Goal 7 (Ensure access to affordable, reliable, sustainable and modern energy for all) and Goal 13 (Take urgent action to combat climate change and its impacts) of the Sustainable Development Goals (SDGs) established by the United Nations.

The disclosure is not limited to the embodiments described above and can be modified in various ways within the range that does not deviate from the essence of the disclosure. For example, the above embodiment illustrates that the motor device 10 is the drive source of an electric brake device mounted in a vehicle such as an automobile, but the disclosure is not limited thereto and can also be applied to drive sources of other in-vehicle equipment (such as drive sources of electric power steering, etc.).

Additionally, the material, shape, dimensions, number, installation location, etc. of each component in the above embodiment are arbitrary as long as they can achieve the disclosure, and are not limited to the above embodiment.

What is claimed is:

1. A motor device, comprising:
a rotation shaft; and
a fixed component fixed to the rotation shaft,
wherein the rotation shaft comprises:
a straight portion in which an outer diameter is constant toward an axial direction of the rotation shaft;
a tapered portion which is provided on one axial side of the straight portion and in which an outer diameter gradually decreases as the tapered portion extends away from the straight portion; and
a connecting portion which is provided between the straight portion and the tapered portion,
wherein the connecting portion connects an outer peripheral surface of the straight portion and an outer peripheral surface of the tapered portion with an arc surface when viewed from a radial outer side of the rotation shaft, and
wherein the fixed component comprises:
a press-fitting cylindrical portion into which the straight portion is press-fitted; and
a gap-forming cylindrical portion which is provided on one axial side of the press-fitting cylindrical portion and which forms a gap with the connecting portion in a radial direction of the rotation shaft.

2. The motor device according to claim 1, wherein the rotation shaft has a hardness higher than a hardness of the fixed component.

3. The motor device according to claim 1, wherein a mounting guide tapered surface which guides mounting of the straight portion to the press-fitting cylindrical portion is provided at an axial end portion of the press-fitting cylindrical portion.

4. The motor device according to claim 3, wherein the mounting guide tapered surface has an angle on an acute angle side with respect to an axis line of the rotation shaft, which is 45 degrees or less.

5. The motor device according to claim 1, wherein the fixed component is a holder member which holds a sensor magnet used to detect a rotation state of the rotation shaft.
